(19) United States
(12) Patent Application Publication
(10) Pub. No.: US 2006/0072596 A1
(43) Pub. Date: Apr. 6, 2006

(54) Method for minimizing buffer delay effects in streaming digital content

(75) Inventors: Michael Spilo, Greenwich, CT (US); Jonathan Daub, Ny, NY (US)

Correspondence Address: DARBY & DARBY P.C., P. O. BOX 5257, NEW YORK, NY, 10150-5257, US

(73) Assignee: Skipjam Corp., Greenwich, CT (US)

(21) Appl. No.: 10/958,637

(22) Filed: Oct. 5, 2004

(51) Int. Cl. H04L 12/56

(52) U.S. Cl. 370/412; 709/231

(57) ABSTRACT

A system and method that selectively discards contents of a buffer memory containing audio-visual digital media content in response to a media switching event. The system includes at least one server in communication with a digital media source and connected to a network. At least one receiver is also connected to the network and includes a display device that presents audible and visual information to a user. The buffer memory can be located in either the receiver, server or both devices. Upon generation and detection of the media switching event, the contents of the buffer are discarded so as to minimize the time-delay of changing the display information.

### FIELD OF INVENTION

The present invention relates to streaming a video signal between devices connected on a network, and in particular to methods for minimizing buffer delays when presenting the streaming video signal for display.

### BACKGROUND OF THE INVENTION

In a digital media system there is at least a digital media source and a digital media playback device. In a stand-alone system the source and playback device are contained in the same unit. Alternatively, a network configuration provides at lease one separate source or server and one separate player, playback device or receiver that are connected and in communication over a network. The (playback device or) receiver displays digital media content that is sent over the network from a source, typically from or with the participation of a server. When a user wishes to change the display a media switching event is generated. Such an event can include a selection from a DVD menu screen, a fast forward or reverse command, or even selection of another source of digital media. After the media switching event is requested and received by the source or server, the source or server alters the streaming media content being sent over the network. However, before the display changes, any content already stored in content buffers present at the source, server, player and/or receiver must be displayed before the new media content is available for display. Thus, an appreciable and observable delay exits in the prior art before the digital media display changes in response to the media switching event.

Missing from the art is a system and method that minimizes the buffer delay effects present when a media switching event occurs. The present invention can satisfy this and other needs.

### SUMMARY OF THE INVENTION

The present invention relates to minimizing buffer delay effects present in a system that displays digital media content. In accordance with one aspect of the invention a method of minimizing buffer delay effects comprises transmitting a first media stream from a source to a receiver; accumulating the first media stream in at least one buffer, which can be located at proximate to or in association with either or both of the server or receiver; receiving a media switching event, clearing the contents of at least one buffer, preferably all buffers, in response to the media switching event; transmitting a second media stream from the server to the receiver; and accumulating the second media stream in at least one buffer.

In accordance with another aspect of the invention, a system that minimizes delay effects for streaming media comprises one or more receivers, each receiver including a buffer memory, a network interface in communication with the buffer memory, and a processor. Also present is a server that includes a network interface, a processor, and a server buffer in communication with the network interface and processor. The server transmits streaming digital media content to at least one of the receivers over a network connected to the server and the one or more receivers. Either the server processor, the receiver processor or both processors contain program instructions operable to clear at least one of the server buffer or receiver buffer upon generation and detection of a media switching event.

These and other aspects, features, steps and advantages can be further appreciated from the accompanying drawing Figures and description of certain illustrative embodiments.

### BRIEF DESCRIPTION OF THE DRAWING FIGURES

FIG. 1 illustrates an overview of the hardware components associated with one embodiment of a network configured digital media system;

FIG. 2 illustrates the functional blocks for the components of the digital media system of FIG. 1; and

FIG. 3 is a flow diagram illustrating steps in accordance with one embodiment of the invention.

### DEFINITION OF TERMS

The terms used in this specification generally have their ordinary meanings in the art, within the context of the invention, and in the specific context where each term is used. Certain terms are discussed below, or elsewhere in the specification, to provide additional guidance to the practitioner in describing the devices and methods of the invention and how to make and use them. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to the preferred embodiments.

“Playback device,” “player” and “receiver” (collectively, “receiver”) means an appliance that is capable of receiving, rendering, and optionally transmitting audio, video, or audiovisual data, including digital content or media. A receiver can also be a source or server for one or more other receivers when configured with such capabilities.

“Source” and “server” (collectively, “server”) means an appliance capable of rendering and transmitting audio, video or audiovisual data, including digital content or media. A server can also be a receiver, when configured with such capabilities.

“Audio,” “video,” “audiovisual data,” “audiovisual media,” “media content,” and the like, mean any information in any analog or digital format which can be displayed, rendered or perceived in sight and/or sound, with or without any other accompanying information that is “hidden,” i.e., not displayed, rendered or perceived. For example, “audiovisual data” includes both digital and/or analog media containing audio and/or video data. Likewise, “content” also refers to the audio and/or video data, with or without additional “hidden” information.

“Digital content,” “Digital media” or a “digital signal” and the like means any digital representation of an audio and/or video performance, of any content and in any format, with or without additional non-representational information, e.g., control, header, metadata information, etc., and whether or not the digital media or signal is converted from or to an analog signal. Many digital media formats are known, including for example, MP3, MPEG, JPEG, TIFF, Real Media and Windows Media. Digital media may also be stored in any physical form, such as on a hard drive, in solid state memory, on a CD or DVD, tape, etc. The hard drive and memory can be stand-alone devices connectable to a network or a Personal Computer, or may be connectable or located in the Personal Computer itself.

Digital media (or a digital signal) may be converted to analog media (or an analog signal), e.g., for display, rendering and perception by a user. For example, an audiovisual presentation stored in a digital format may be converted to one or more analog signals for display of images and/or sound on an analog display device, such as a conventional television. Alternatively, a digital signal may be rendered on a digital display without conversion to an analog signal. Digital audio and visual media or signals may be rendered separately or together, with or without analog conversion. For example, digital video or images may be rendered on a digital display, while corresponding digital audio media or data is converted to an analog signal for playback by an analog speaker system. Methods for digital-to-analog conversion are known, as are methods to synchronize the audio and video portions of a signal during its playback.

“Analog media” or an “analog signal” means any analog representation of an audio and/or video performance, whether or not the analog media or signal is converted from or to digital data or a digital signal. Thus, an analog signal may optionally be captured and converted to digital media for storage and/or transmission to other devices for playback. For example, images from a digital camera, or audio from a telephone device, such as an IP telephone, may be converted from analog to digital signals by the camera or telephone, or by another device or process e.g., residing on a network.

### DETAILED DESCRIPTION OF THE ILLUSTRATIVE EMBODIMENTS

By way of overview and introduction, presented and described are embodiments of a method to minimize buffer delays in a streaming video presentation. In one embodiment of the invention, content contained in device buffers connected to a network is discarded (i.e., cleared, emptied, etc.) upon an event trigger so that the streaming video present on the network is available for display to a user with a minimal, imperceptible delay.

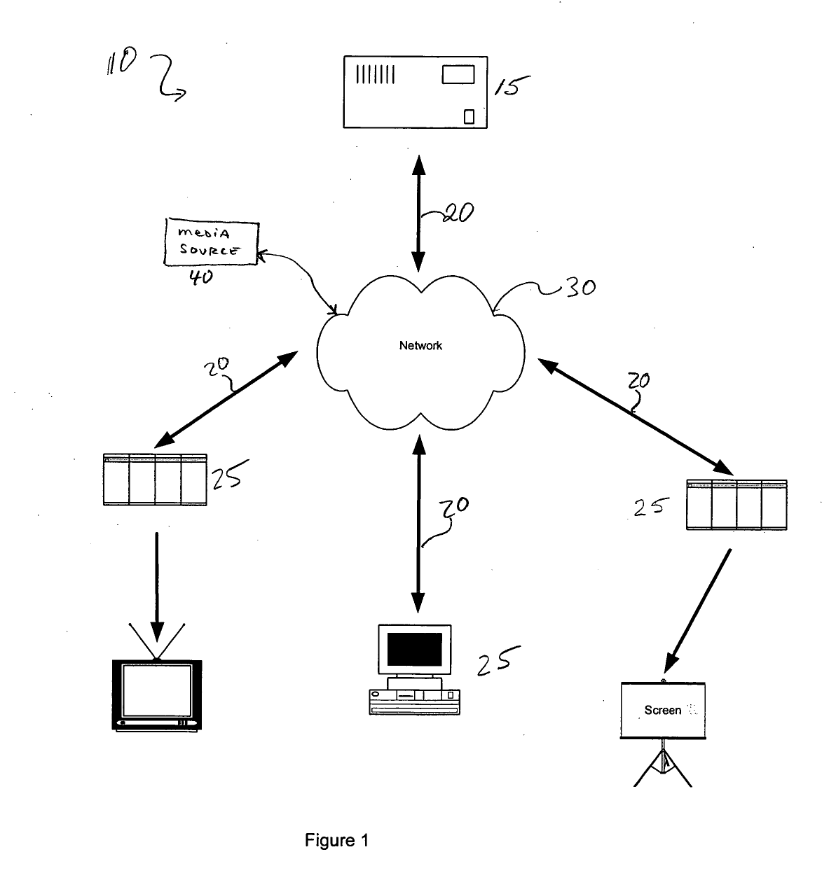

With reference to FIG. 1, a networked digital media system 10 typically comprises a digital content source (a “server”) 15, one or more network paths or channels 20 for the video signal, and one or more playback devices (or receivers) 25 for rendering the signals. The server 15 can itself incorporate capabilities to render the video signals. Thus, a server 15 can also be a receiver 25, and vice versa. The playback device 25 provides the digital media content to one or a variety of devices for display, including a television, a PC monitor, or a projection display system. The server 15 and the receiver 25 are connected and communicate through a network 30.

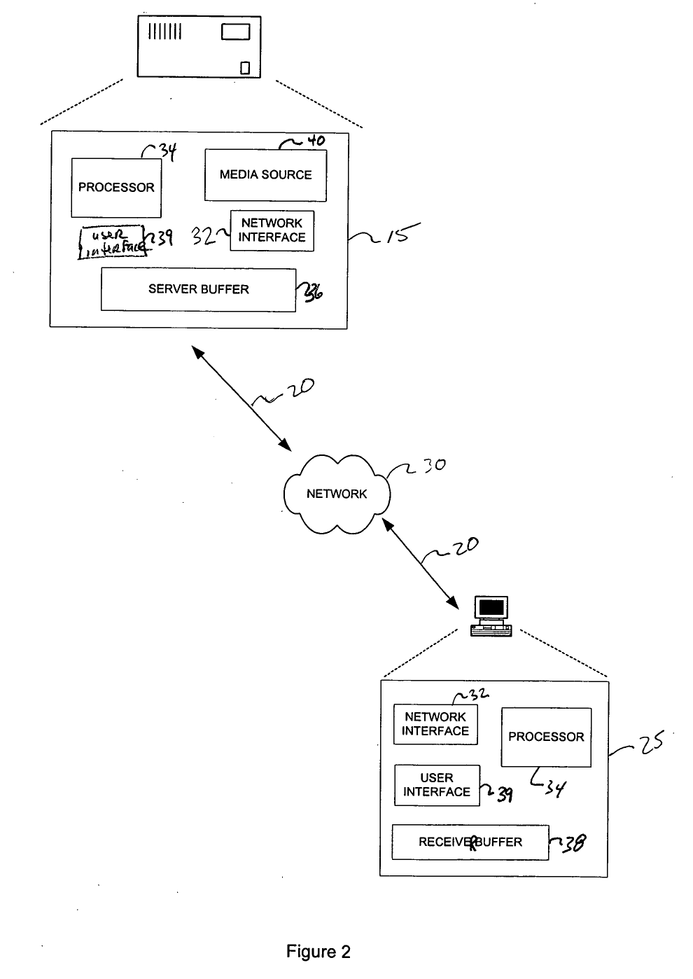

FIG. 2 illustrates functional blocks for the components of the digital media system 10. These functional blocks can be implemented in hardware or software, or a combination of hardware and software, as is known by a practitioner of ordinary skill in the art. The server 15 and receiver 25 each include a processor unit 32 for controlling the operation of the device, and a network interface 34 for communicating with the other devices connected to the network 30. Importantly, the source 15 and playback devices 25 each, respectively, comprise a server buffer 36 or a receiver buffer 38. The server further includes a media source component 40, where digital media content is stored and/or rendered for transmission to the receiver 25.

The processor component 32 acts as a controller for the overall operation of its local device and controls its operation. The processor is typically implemented as a single microprocessor or microcontroller with associated memory, program memory storage, working memory and interfaces. Alternatively, processor 32 can be implemented in a distributed architecture where more than one processor is used to control the device's particular functionality and these several processors can be located throughout the device, or may be spread among associated devices.

The network interface 34 connects the server 15 and the receiver 25 to the network 30. Digital media is streamed from the server to the receiver along network channel 20. Also, control signals from the receiver are transmitted along channel 20 to the server. The network communication can be accomplished through any protocol, preferably standardized network protocols such as Ethernet (IEEE 802.3) or any of its physically connected variants, wireless communication protocols (i.e. IEEE 802.11x, where x can be ‘a’, ‘b,’ ‘g,’ or a developing standard—e.g., ‘e’), or the network communication could run under a proprietary or modified protocol. Alternatively, communication could be accomplished over a heterogeneous network consisting of many different protocols. The specifications for IEEE 802.3, 802.11a, 802.11b, 802.11e, and 802.11g are hereby incorporated by reference in their respective entireties.

The network interface 34 connects the source device and the receiver device to the network 30 and coordinates signal and data transfer among the devices. The coordination of messages between devices located on the network is controlled via handshaking according to the aforementioned network protocols, implemented via the network interface. The network interface 34 can further include a memory buffer (not shown) that stores messages for processing and a processor (not shown) having software along with associated memory and instruction sets (not shown). Alternatively, network interface 34 can be a software module which executes under the control of processor 32.

The user interface 39 can take the form of a keyboard, keypad or a set of buttons on the server 15 or receiver 25 unit itself, or a remote control (e.g., infra-red, RF, etc.) paired with a remote control receiver associated with the server or receiver unit. Additionally, the receiver 25 may present an on-screen menu which a user may navigate with the aid of the remote control or keypad. Similarly, the server 15 can also include a display screen for presenting a navigation menu. Alternatively, a web based interface, or a remote computer program can be available to allow a user to control the devices' operation. The display may be any audiovisual display including a television, computer monitor, LCD display, touchscreen, etc. The user interface may be associated with one or more servers, one or more receivers, or may be adapted to interface with all servers and receivers on the network.

The media source component 40 located within server 15 may be implemented with conventional technology, and can be capable of rendering any form of recorded media, e.g., DVD, CD, MPEG, MP3, audio or video tape, etc. Additionally, the media source 40 can be capable of supplying live media content, such as TV or cable video sources, AM./FM audio sources, or Internet streaming sources. Digital media system 10 can include one or more playback devices each including multiple media source components 40 capable of operating in more than one technology. In one embodiment of system 10, a video MPEG playback processor, a digital audio playback processor and a personal computer CPU can comprise the playback components of the playback devices.

For example, to play back MPEG encoded data content, a subsystem implemented through hardware, software, or a combination of hardware and software, can be employed to render the MPEG content for analog or digital display. To play from a DVD or CD, an optical reader in the form of a laser head is employed in media source 40 to read information encoded on an optical disc. Conversely for audio or video tape, information is stored in the form of magnetic pulses which is read from the tape as it passes in proximity to a magnetic head. The invention is not limited to the format or technology of the digital medium which stores and reads the digital content. Embodiments of the server 15 can have a media source component 40 that is capable of playing from more than one media technology, e.g., both audio tape and CD, or MPEG in combination, or to play digital files stored on a local or remote data store (not shown), or streamed directly from either the Internet (not shown) or an external data store device (not shown).

Again referring to FIG. 2, the server 15 has access to a form of digital media content through media source 40. The digital media can be a Digital Versatile Disc (DVD), an audio compact disc (CD), a television or radio broadcast that is either transmitted digitally or converted into digital data, some form of media residing on an optional hard drive on the server such as music, video, and/or a slideshow, or any other form of media which can be encoded for digital transmission.

During operation, the server buffer 36 stores segments of the media to be transmitted to the receiver 25. Upon receipt at the receiver, the receiver buffer 38 stores the media content prior to display, as described below. The server 15 typically pre-fetches the media content ahead of transmission, and stores it in the buffer 38. In other words, as the server 15 is transmitting portion A of the media content, the server is reading portion B from the media source 40, and storing it in the buffer 38. Chronologically portion B is later in the media content than portion A. To account for network transmission delay, portion B is preferably 1 to 2 seconds in playback duration. Consequently, the server buffer 38 is preferably capable of accumulating at least 1 to 2 seconds of media content. This buffering is performed to ensure that the media content, which is typically fetched by or delivered to the server 15 at a constant rate in real-time, is still available when the server 15 is able to transmit the media content. The buffering also ensures that the server 15 will have very fast access to the next portion of the media content which is to be transmitted, thereby minimizing any gaps or delays in the media content as it is transmitted to and displayed on the receiver. Various forms of media content may require different sizes of memory to store 1 to 2 seconds worth of data, therefore the server buffer 38 can be dynamically sized depending on the medium. Further for a given medium, the buffer can be resized as the system 10 is operating to allow for buffering of more or less media content.

Buffering of the transmitted digital media content can be done in real-time (i.e., reading from the media source at rate equal to the rate at which the media content is displayed). However, the invention is not so limited, and the above-described buffering does not need to be done in real-time. Server 15 can read and buffer data as fast as it is capable, and is not required to read some definite time period (i.e. 1 to 2 seconds) in lockstep ahead of what is being transmitted. Furthermore, when the server begins transmitting a new media stream, it is not required to completely fill the buffer 38 before beginning the transmission of the stream. The server can be programmed to begin transmitting data immediately without any pre-fetched data in the buffer. Because the server can read data faster than it needs to send data, the buffer 38 should eventually fill. Alternatively, the server can be programmed to require some portion of the media (i.e. anywhere from none to the full amount of buffer space) to be buffered before it begins transmitting to the receiver. Additionally, the server can transmit data in faster than real-time to the receiver. This is useful when the receiver contains its own buffer.

The server 15 is capable of streaming digital media content to more than one receiver 25. Alternatively, the server can stream digital media content from other media sources connected to the network 40, limited only by the sophistication and speed of the network hardware and software. Each pairing of a unique server 15 (along with internal media source 40, or an external source) to the receiver 25 requires a dedicated server buffer 38.

If the server is streaming the same digital media content to more than one receiver 25 connected to the network 40, the server can optionally use the same buffer for each data stream, or use different buffers. However, if the server is streaming media content A to a first receiver and media content B to second receiver, two different server buffers must be used. These different server buffers can be separate physical memory, or partitions of memory within the same memory device, and may be at the server and/or the receiver. In one embodiment, event switching delays are minimized by clearing or flushing a buffer associated with a server for the affected content, so that all affected receivers are serviced in one operation, at one source.

The receiver 25 may include a receiver buffer 38 so that a seamless display of the digital media content is provided to a user. The receiver buffer stores data being transmitted by the server 15. The receiver can be configured, such that as the receiver begins to receive a new media stream, it will fill a portion of the buffer 38 before displaying the media stream. The portion of the buffer which must be filled before beginning the display can range from none to the entire buffer. In order to assure a seamless display, the digital media system 10 typically will need some portion of the streaming video to be buffered before beginning the display.

In one embodiment, the receiver 25 sends requests for portions of the digital media stream to the server 15. These requests are for portions of the media content which are chronologically ahead of what the receiver is displaying. However, if the receiver should need to display the next data in the media stream, and that data is not in the receiver buffer 38, the receiver can pause and re-buffer the data as though it were receiving a new media stream. Thus, the receiver is not required to buffer data in real-time. Upon receiving a new media stream, or if the buffer 38 becomes less than full, the receiver 25 can accept and buffer data from the server 15 at the same rate as it is received.

During operation of the digital media system 10, a media switching event can occur which triggers a response among the components of the system. For instance, one type of media switching event is anything that triggers the server to switch from one media stream to another media stream. The change in media stream does not necessarily mean a change in the media source, or even a change from one media stream to another media stream. For instance, a user may request that the server jump from chapter 1 of a DVD to chapter 2 of the DVD, or the user may request that the media stream playback speed be adjusted (e.g., fast forward, rewind, slow motion or pause). While these may be viewed as the same media source, and a continuation of the same or different media streams, it is a media switching event within the context of the present invention. Any event which requires the server 15 and/or the receiver 25 to read from a portion of a media source which is not currently playing or already located in its respective buffer can be a media switching event. Additionally, media switching events can involve switching between different media types. Further examples of media switching events include: the user selecting play from a DVD menu thereby switching from the menu stream to the movie stream, switching tracks on a CD, changing channels or stations on a cable or tuner source, and/or switching from listening to a CD to viewing a slide show.

For example, the digital media system 10 can be operated to render content on a display associated with a receiver 25, by selection from the menu of a DVD located in or attached to a media source 40. The digital media content can also be obtained from a file located on a data store local the network 30, or from a file obtained external to the network via the Internet. While the digital media system 10 is displaying the DVD menu, the server buffer 36, the receiver buffer 38, or both if present, contain the DVD menu display data. Selection of a DVD menu item by the user generates a media switching event. After a media switching event is triggered, the contents of one or both buffers is discarded and streaming data is delivered to the now emptied buffer(s), so as to be presented to the receiver's display unit in less time than if the previous buffer content was displayed and not discarded.

In a preferred embodiment, media switching events are detected by the receiver 25 and can be generated by different sources. As demonstrated in the previous examples, a user could press a button on a remote control thereby generating one of the aforementioned examples of media switching events. Alternatively, a user can generate a media switching event from any of the user interface units 39 located in the server or receiver(s), or a computer or web based program that controls the digital media system 10. Additionally a media switching event can be generated autonomously, such as through a timed or alarmed event.

When a receiver (or a user interface associated with a receiver) detects a media switching event, a series of actions is set in motion. In one embodiment, the receiver network interface 32 will send the details of the event over network 30 to the server network interface 32, clear its receiver buffer 38, and begin to re-buffer the new media stream once the server begins to transmit the new media stream, as described above. When the server 15 receives notification of the media switching event, it clears its server buffer 36, or the server buffer associated with that receiver if more than one receiver is present, and begins to buffer the new media stream and transmit it to the receiver.

It is not required that both the server and receiver buffer contents be discarded. Buffer delay effects are reduced even if only the receiver buffer is cleared, or if only the server buffer is cleared. Clearing the buffers on the receiver and/or server effectively reduces the amount of media data in the queue that must be displayed and transmitted before the system 10 displays the new media stream. Optionally, a network interface buffer (if present) can be cleared independently or in conjunction with clearing the receiver and/or server buffers

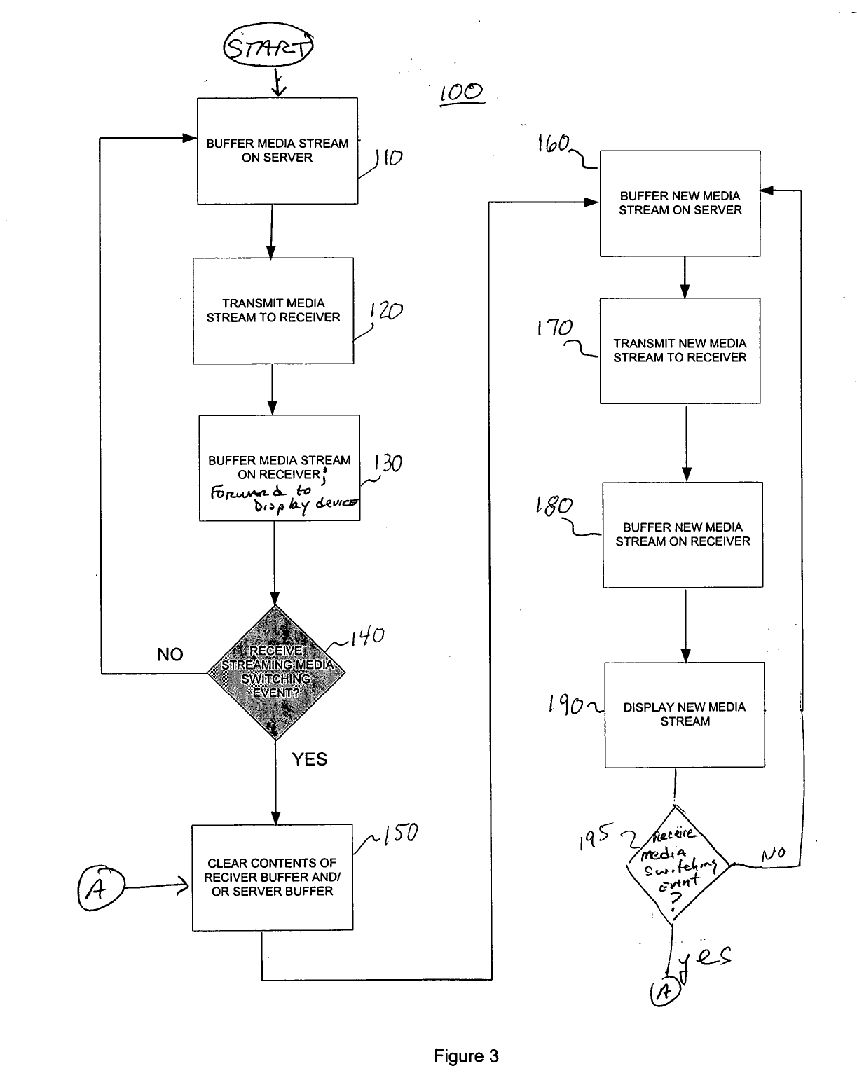

FIG. 3 illustrates process 100, which embodies one method of buffer delay minimization. At step 110, the server accesses the media source 40 and begins to buffer the digital media content in the server buffer 36. As the digital content is delivered to the buffer and then exits the buffer, it is transmitted on to the network 30 through server network interface 32, step 120. The receiver 25 receives the digital media content through its own network interface 32 and if a receiver buffer 38 is present, collects the media stream in the buffer, step 130. The media stream is presented on the display for visual and audio perception by the user. The media stream across the network is continuously presented on the display as described above for steps 110-130 until a media switching event is received. If a media switching event is generated, step 140, process 100 proceeds to step 150 where the contents of the server buffer, receiver buffer, and/or both buffers is discarded; i.e., cleared. The server, in response to the media switching event of step 140, obtains a new media stream from media source 40, step 160, and buffers the media stream. Alternatively, the server merely continues from a new position in the same media stream. Steps 170 through 190 cause the media content to be streamed to the receiver from the server, and have the content displayed on a display unit. At step 195, a determination is made on whether a media switching event has been generated. If a media switching event was generated, process 100 continues at step 150 and the contents of the server buffer, receiver buffer, and/or both buffers is discarded, as described above. If no switching event is generated, process 100 returns to step 160 and the media streaming continues. As will be understood by a person of ordinary skill, a media switching event can be generated at any time during process 100, and its generation and response, steps 140 and 195, can be handled on an interrupt basis at any appropriate point during the process.

In one embodiment, prior to the server accessing the streaming digital media content and accumulating data in its buffer 36, the server retrieves an initial frame from the media source 40. The server transmits this initial frame to the receiver in the manner described above for the streaming digital media content. The initial frame itself can be transmitted with or without the need for buffering, depending on such factors as the initial frame size, network speed, network bandwidth and overhead, along with other parameters that are known by a person of ordinary skill in the art. The initial frame is displayed on the display device connected to the receiver 25, and held while the server accesses the digital streaming media content, as described above. The initial frame can be a single audiovisual image, a loopback audiovisual image (i.e., a data block that returns to its beginning for uninterrupted display), or a continuous audiovisual display. For live media content sources, such as television or radio media sources, the continuous audiovisual display is the preferred embodiment of an initial frame.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one described embodiment to another are also fully intended and contemplated. The method steps of the invention can be performed in any order, as will be understood by persons of ordinary skill in the art. The invention is defined solely with regard to the claims appended hereto, and equivalents of the recitations therein.

We claim:

1. A method of minimizing buffer delay effects in a digital rendering system, comprising the steps of:
accumulating a portion of a first media stream in at least a first buffer;
transmitting the first media stream from a server to a receiver;
receiving a media switching event;
clearing the contents of the first buffer in response to the media switching event;
accumulating a portion of a second media stream in the first buffer; and
transmitting the second media stream from the server to the receiver.

2. The method of claim 1, wherein the first buffer is located at the server.

3. The method of claim 1, wherein the first buffer is located at the receiver.

4. The method of claim 1, wherein the first buffer is located at the server and a second buffer is located at the receiver.

5. The method of claim 4, further comprising the step of accumulating at least one of the first media stream and the second media stream in the second buffer.

6. The method of claim 5, further comprising the step of clearing the second buffer in response to the media switching event.

7. The method of claim 1, wherein the media switching event is initiated by a user.

8. The method of claim 1, wherein the media switching event is performed by the server.

9. The method of claim 1, wherein the media switching event is initiated by the receiver.

10. The method of claim 1, wherein the transmitting steps are performed over a network.

11. The method of claim 10, wherein the network is a wireless network.

12. The method of claim 10, wherein the network includes a wired network.

13. The method of claim 1, wherein the first media stream and the second media stream comprise at least one of audio, video, and audiovisual data content.

14. The method of claim 1, wherein the first buffer is resizable.

15. The method of claim 1, wherein the first buffer is a ring buffer.

16. The method of claim 1, wherein the transmission of the second media stream is faster than real-time playback speed.

17. The method of claim 1, further comprising the step of displaying the media stream on a display device in communication with the receiver.

18. The method of claim 10, wherein the network includes physical connections and wireless connections.

19. The method of claim 1, wherein the second media stream is a continuation of the first media stream.

20. The method of claim 1, further comprising the step of the server transmitting an initial frame to the receiver;
wherein the frame is one of a single audiovisual display, a loopback audiovisual display, and a continuous audiovisual display.

21. The method of claim 20, wherein the initial frame is transmitted prior to the accumulating steps.

22. A system of minimizing delay effects for streaming media comprising:
one or more receivers, each receiver including a buffer memory, a network interface in communication with the buffer memory, and a processor;
a server that includes a network interface, a processor, a server buffer in communication with the network interface and processor, wherein the server transmits streaming digital media content to at least one of the receivers;
a network connected to the server and the one or more receivers; and
a digital media source, which contains the digital media content, connected to the network;
the system configured such that at least one of the server processor or the receiver processor contains program instructions operable to clear digital media content accumulated in at least one of the server buffer and receiver buffer upon generation and detection of a media switching event.

23. The system of claim 22, further comprising an initial frame stored in the digital media store;
wherein the frame is one of a single audiovisual display, a loopback audiovisual display, and a continuous audiovisual display.

24. The system of claim 23, wherein the server transmits the initial frame to the receiver prior to transmitting the streaming digital media content.
